(19) United States
(12) Patent Application Publication
(10) Pub. No.: US 2011/0252976 A1
(43) Pub. Date: Oct. 20, 2011

(54) BEVERAGE PREPARING APPARATUS

(76) Inventor: TSUNG-HSI LIU, Taipei (TW)

(21) Appl. No.: 12/873,282

(22) Filed: Aug. 31, 2010

(30) Foreign Application Priority Data
Apr. 16, 2010 (TW) 099111960

(51) Int. Cl. A47J 31/44

(52) U.S. Cl. 99/288

(57) ABSTRACT

A beverage preparing apparatus mixes hot water from a hot water pipe with cold water from a cold water pipe to produce a mixed water flow with an appropriate temperature to be delivered to a liquid dispenser. When a brewing solenoid valve is opened, the liquid dispenser delivers the mixed water flow to a preparing container that contains a beverage composition to prepare a beverage. When the brewing solenoid valve is shut, the liquid dispenser delivers the mixed water flow into a hot water inlet pipe. When a hot water inlet solenoid valve is opened, the mixed water flow is added into the beverage directly. When the brewing solenoid valve and hot water inlet solenoid valve are shut, the hot water in the heat exchanger is vaporized and passed through a pre-heating circulation pipeline to pre-heat the liquid dispenser and returned to a heat exchanger to constitute a pre-heating circulation.

### CROSS-REFERENCE TO RELATED APPLICATION

This application claims priority of Taiwanese Patent Application No. 099111960 filed on Apr. 16, 2010.

### BACKGROUND OF THE INVENTION

1. Field of the Invention

The present invention relates to a beverage preparing apparatus, and more particularly to a beverage preparing machine that can prepare various different types of beverages at different temperatures and concentrations.

2. Description of the Related Art

In general, a beverage preparing apparatus is used for brewing coffee, tea or other beverages. With reference to FIG. 17 for a conventional beverage preparing apparatus, the apparatus comprises a water pump 80, a main boiler 81, a heat exchanger 82 and a liquid dispenser 83. The water pump 80 is provided for supplying water from an external water source to the main boiler 81. A water level detector 84 is provided for controlling the water pump 80 and an water inlet solenoid valve 95 of the main boiler 81 to be opened or shut, such that the water level of the main boiler 81 can be maintained within a predetermined range; a steam pressure detector 85 is provided for controlling a heater 86 to be opened or shut and heating the water stored in the main boiler 81 in order to maintain the main boiler 81 within a predetermined steam pressure range (or a predetermined temperature range).

In a beverage preparing process, the water pump 80 and a brewing solenoid valve 87 are opened to supply water from an external water source through a cold water supply pipe, a one-way pressure relief valve 89 and a flow meter 90 and deliver the water into heat exchanger 82 of the main boiler 81, and the hot water and steam in the main boiler 81 are used for heating the water from the external water source contained in heat exchanger 82 to produce hot water, and the hot water flows from a hot water supply pipe 91 into the liquid dispenser 83, passes through the opened brewing solenoid valve 87 and flows downwardly to a preparing container 92 that contains a beverage composition for brewing the beverage. The brewed beverage flows into a beverage containing cup 94. If a predetermined quantity of water flow measured by the flow meter 90 is reached, the brewing solenoid valve 87 and the water pump 80 will be shut immediately to complete setting the water flow in the beverage brewing process.

If the conventional beverage preparing apparatus is idled, the hot water in the heat exchanger 82 will vaporize to steam by the heat of vaporization, and the steam will pass through the hot water supply pipe 91 into the liquid dispenser 83. Since the brewing solenoid valve 87 is shut during the idle stage, heat exchanges take place between the steam flow and the liquid dispenser 83. After the liquid dispenser 83 is pre-heated to an operating temperature, the steam is condensed to water by the heat exchanges with the liquid dispenser 83, and the condensed water flows from a return pipe 93 into the heat exchanger 82 to constitute a pre-heating circulation.

The aforementioned conventional beverage preparing apparatus can supply hot water at only one temperature to the liquid dispenser for brewing the beverage, and the temperature and concentration of the prepared beverage are constants, and thus it cannot prepare beverages at different temperatures and concentrations to fulfill individual preference and meet the actual requirements of the diversified beverage market.

In general, most present beverage makers change the temperature and concentration of the beverage by adding hot water, cold water and/or ice cubes manually into the brewed beverage, but such manual process not only takes much time, but also fails to maintain the best quality and taste of the beverage or incurs customers' unsatisfaction caused by a long wait and/or a poor beverage quality.

Furthermore, the best brewing temperature for different types of beverages (such as coffee, green tea, and red tea) varies. Although the conventional beverage preparing apparatus can install two or more sets of liquid dispensers and preparing containers, the hot water supply system can supply hot water at only one temperature to each liquid dispenser and each preparing container for performing the beverage brewing process, so that the apparatus is preset for brewing the same type of beverage, and it is generally called “Single beverage preparing apparatus”. As to beverage makers having a market requirement for various different beverages, several different beverage preparing apparatuses are required for brewing different types of beverages. Such arrangement not only increases the equipment cost, but also causes the disadvantages of an inconvenient operation and a low equipment utilization rate.

### SUMMARY OF THE INVENTION

Therefore, it is a primary objective of the present invention to provide a beverage preparing apparatus, wherein after a beverage brewing process takes place, a specific volume of water set by a user is added into a beverage to change the concentration of the beverage. The present invention not only provides a quick and convenient operation, but also maintains the best quality and taste of the beverage.

Another objective of the present invention is to provide a beverage preparing apparatus, wherein the filling water includes hot water and/or cold water provided for changing the temperature and/or concentration of the beverage.

Another objective of the present invention is to provide a beverage preparing apparatus, wherein the hot water with a temperature higher than the required brewing temperature is mixed with a specific quantity of cold water to produce a mixed water flow at a temperature most suitable for brewing the beverage, and the liquid dispenser delivers the mixed water into a preparing container for brewing the beverage. The aforementioned brewing method of using a mixed water flow not only improves the working efficiency of a boiler, but also achieves the effect of brewing various types of beverages by installing two or more sets of liquid dispensers and preparing containers to the beverage preparing apparatus to adjust the flow of cold water and deliver the mixed water flow at different temperatures to different liquid dispensers. Therefore, the beverage preparing apparatus of the present invention can come with two or more sets of liquid dispensers and preparing containers for brewing two or more types of beverages. As to beverage makers, the present invention has the advantages of reducing equipment cost, providing convenient operation, and improving equipment utilization rate.

Another objective of the present invention is to provide a beverage preparing apparatus that further provides a pre-heating circulation path to assure the pre-heating effect of the liquid dispenser.

To achieve the foregoing objective, the present invention provides a beverage preparing apparatus, comprising: a boiler, for heating water stored therein to a predetermined temperature range; a hot water pipe, connected to an external water source, and passed through a heat exchanger installed in the boiler, for heating a water flow passing through the hot water pipe to an overheated temperature value; a cold water pipe, connected to the external water source, passed through a cold water throttle valve for adjusting a flow, and then connected to the hot water pipe, such that the cold water and the hot water are mixed into a water flow with an appropriate temperature; a check valve, installed on the cold water pipe, for preventing the water flow in the hot water pipe from flowing in a reverse direction back into the cold water pipe; a liquid dispenser, connected to the hot water pipe, for receiving the water flow from the hot water pipe; a preparing container, assembled with the liquid dispenser, and having a beverage composition contained in the preparing container; a hot water inlet pipe, connected to the hot water pipe through the liquid dispenser; a hot water inlet solenoid valve, for controlling the hot water inlet pipe to be opened or shut; and a brewing solenoid valve, installed onto the liquid dispenser, such that when the brewing solenoid valve is opened, the liquid dispenser delivers a mixed water flow at an appropriate temperature into the preparing container to produce a beverage by the beverage composition, and when the brewing solenoid valve and the hot water inlet solenoid valve are opened, the liquid dispenser delivers a mixed water flow at an appropriate temperature into the hot water inlet pipe and adds the mixed water into the beverage.

In a preferred embodiment, the beverage preparing apparatus further comprises a pre-heating circulation pipeline, with an end connected to the hot water pipe, and another end passed through the liquid dispenser directly, and then connected to the heat exchanger, such that when the brewing solenoid valve and the hot water inlet solenoid valve are shut, the hot water in the heat exchanger is vaporized and passed through the pre-heating circulation pipeline to pre-heat the liquid dispenser, and then returned to the heat exchanger.

In a preferred embodiment, the beverage preparing apparatus further comprises a cold water inlet pipe connected to an external water source and a cold water inlet solenoid valve provided for controlling the cold water inlet pipe to be opened or shut, such that when the cold water inlet solenoid valve is opened, the external cold water is passed through the cold water inlet pipe to add the cold water into the beverage.

In a preferred embodiment, the cold water pipe is connected to the hot water pipe before the hot water pipe enters into the liquid dispenser.

In a preferred embodiment, the cold water pipe is connected to the hot water pipe through the liquid dispenser.

In a preferred embodiment, the beverage preparing apparatus further comprises a control panel having at least three manual control keys and at least four automatic control keys, and the manual control keys being provided for controlling the brewing solenoid valve, the cold water inlet solenoid valve and the hot water inlet solenoid valve manually and respectively, and the automatic control keys being preset and provided for controlling the brewing solenoid valve, the cold water inlet solenoid valve, the hot water inlet solenoid valve and their combinations automatically and respectively.

In a preferred embodiment, the beverage preparing apparatus further comprises at least two sets of cold water pipes, cold water throttle valves, hot water pipes and liquid dispensers, and the cold water throttle valves providing different flows of cold water to the cold water pipes, and the hot water in the sets of hot water pipe being mixed to form a mixed water flow of an appropriate temperature and delivered to the liquid dispensers.

In a preferred embodiment, the hot water inlet solenoid valve is installed on the hot water inlet pipe.

In a preferred embodiment, the hot water inlet solenoid valve is installed on the liquid dispenser such that when the brewing solenoid valve is opened and the hot water inlet solenoid valve is shut, the mixed water flow at an appropriate temperature flows into a water supply passage of the liquid dispenser, passes through the opened brewing solenoid valve into a water exit passage, and flows into the preparing container for performing a beverage brewing process, and when the brewing solenoid valve is shut and the hot water inlet solenoid valve is opened, the mixed water flow at the appropriate temperature passes through the water supply passage, and then the opened hot water inlet solenoid valve into a water supply branch passage, and flows into the hot water inlet pipe.

### BRIEF DESCRIPTION OF THE DRAWINGS

The invention, as well as its many advantages, may be further understood by the following detailed description and drawings in which:

FIG. 1 is a perspective view of a beverage preparing apparatus in accordance with a first preferred embodiment of the present invention;

FIG. 2 is a top view of the beverage preparing apparatus as depicted in FIG. 1;

FIG. 3 is a perspective view of a beverage preparing apparatus in accordance with a second preferred embodiment of the present invention;

FIG. 4 is a top view of the beverage preparing apparatus as depicted in FIG. 3;

FIG. 5 is a schematic view of the beverage preparing apparatus as depicted in FIG. 3;

FIG. 6 is a perspective view of a cold water (hot water) inlet throttle connector installed in the beverage preparing apparatus in accordance with a second preferred embodiment of the present invention;

FIG. 7 is a schematic view showing the water flow direction in a beverage brewing process carried out by the beverage preparing apparatus as depicted in FIG. 3;

FIG. 8 is a schematic view showing the water flow direction in a hot water filling process carried out by the beverage preparing apparatus as depicted in FIG. 3;

FIG. 9 is a schematic view showing the water flow direction in a cold water filling process carried out the beverage preparing apparatus as depicted in FIG. 3;

FIG. 10 is a schematic view showing the water flow direction in a preheating circulation process carried out the beverage preparing apparatus as depicted in FIG. 3;

FIG. 11 is a top view of a beverage preparing apparatus in accordance with a third preferred embodiment of the present invention;

FIG. 12 is a perspective view of a beverage preparing apparatus in accordance with a fourth preferred embodiment of the present invention;

FIG. 13 is a top view of the beverage preparing apparatus as depicted in FIG. 11;

FIG. 14 is a perspective view of a beverage preparing apparatus in accordance with a fifth preferred embodiment of the present invention;

FIG. 15 is a partial enlarged view of a liquid dispenser installed in the beverage preparing apparatus as depicted in FIG. 14;

FIG. 16 is another partial enlarged view similar to FIG. 14, and viewed from a different cross-sectional direction; and

FIG. 17 is a perspective view of a conventional beverage preparing apparatus.

### DETAILED DESCRIPTION OF THE INVENTION

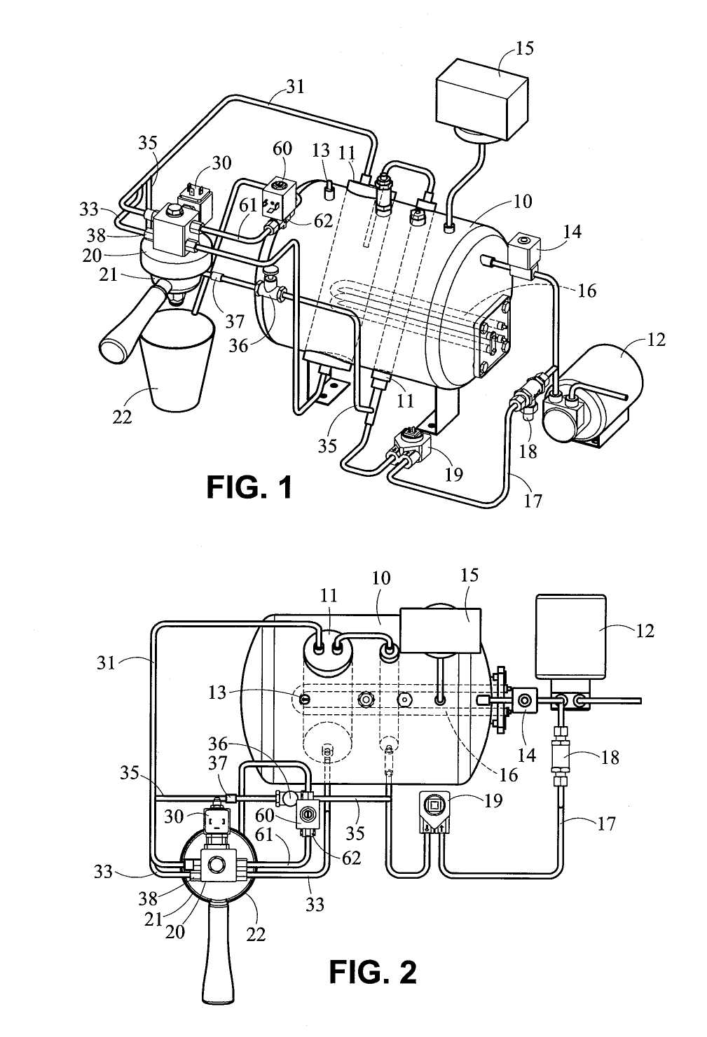

With reference to FIGS. 1 and 2 for a beverage preparing apparatus in accordance with a first preferred embodiment of the present invention, the beverage preparing apparatus mixes hot water from a hot water pipe 31 with a specific quantity of cold water from a cold water pipe 35 to produce a mixed water flow at an appropriate temperature, and uses a liquid dispenser 20 having a brewing solenoid valve 30 to select and deliver the mixed water flow at the appropriate temperature into a preparing container 21 that contains a beverage composition to prepare a beverage from the beverage composition and allow the beverage to flow into a beverage cup 22; or select and deliver the mixed water at the appropriate temperature into a hot water inlet pipe 61 to add the mixed water into the beverage cup 22 directly, so as to change the concentration of the beverage in the beverage cup.

The beverage preparing apparatus comprises: a boiler 10 for heating water contained in the boiler 10 to a predetermined temperature range; a hot water pipe 31 connected to an external water source, and passed through a heat exchanger 11 installed in the boiler 10 for heating a water flow passing through the hot water pipe 31 to an overheated temperature value; a cold water pipe 35 connected to the external water source, and passed through a cold water throttle valve 36 for a flow adjustment, and then connected to the hot water pipe 31, such that cold water and hot water are mixed into a water flow of an appropriate temperature; a check valve 37 installed on the cold water pipe 35 for preventing the water flow in the hot water pipe 31 from returning to the cold water pipe 35; a liquid dispenser 20 connected to the hot water pipe 31 for receiving a water flow from the hot water pipe 31; a preparing container 21 combined with the liquid dispenser 20 and containing a beverage composition in the preparing container 21; a hot water inlet pipe 61 connected to the hot water pipe 31 through the liquid dispenser 20; a hot water inlet solenoid valve 60 installed on the hot water inlet pipe 61 for controlling to open or shut the hot water inlet pipe 61; and a brewing solenoid valve 30 installed on the liquid dispenser 20, such that when the brewing solenoid valve 30 is opened, the liquid dispenser 20 delivers the mixed water flow with an appropriate temperature into the preparing container 21 to prepare a beverage from the beverage composition; and when the brewing solenoid valve 30 is shut, the liquid dispenser 20 delivers the mixed water flow with an appropriate temperature into the hot water inlet pipe 61, and when the hot water inlet solenoid valve 60 is opened, the mixed water flow is added into the beverage directly.

In this preferred embodiment, the cold water pipe 35 is connected to the hot water pipe 31 before the hot water pipe 31 enters into the liquid dispenser 20.

The present invention further comprises a water pump 12 for supplying water from an external water source into the boiler 10, a water level detector 13 for controlling the water pump 12 and a water inlet solenoid valve 14 to be opened or shut, such that the of water level of water contained in boiler 10 is maintained within a predetermined range, a steam pressure detector 15 for controlling a heater 16 to be turned on or off, such that water contained in the boiler 10 can be heated to maintain a predetermined steam pressure range (as well as a predetermined temperature range).

The water pump 12 is connected to a water inlet pipe 17, such that when the water pump 12 is turned on, water from an external water source is pumped into the water inlet pipe 17. The water inlet pipe 17 sequentially includes a one-way pressure relief valve 18 and a flow meter 19, and ends of the water inlet are connected to the hot water pipe 31 and the cold water pipe 35 respectively for supplying the water from the external water source to the hot water pipe 31 and the cold water pipe 35.

The heat exchanger 11 as shown in the figure is a dual boiler type heat exchanger, but it also can be a single boiler type heat exchanger or any other type heat exchanger.

The brewing solenoid valve 30 is installed on the liquid dispenser 20, and the brewing solenoid valve can be a three-way two-position solenoid valve.

The beverage preparing apparatus further comprises a pre-heating circulation pipeline 33 provided for preheating the liquid dispenser 20, wherein an end of the pre-heating circulation pipeline 33 is connected to the hot water pipe 31, and passed through the liquid dispenser 20 directly without any control of the solenoid valve, and another end of the pre-heating circulation pipeline 33 is connected to the heat exchanger 11. A throttle connector 38 is installed at the position where the pre-heating circulation pipeline 33 and the liquid dispenser 20 are connected, and the throttle connector 38 also can be replaced by a throttle valve.

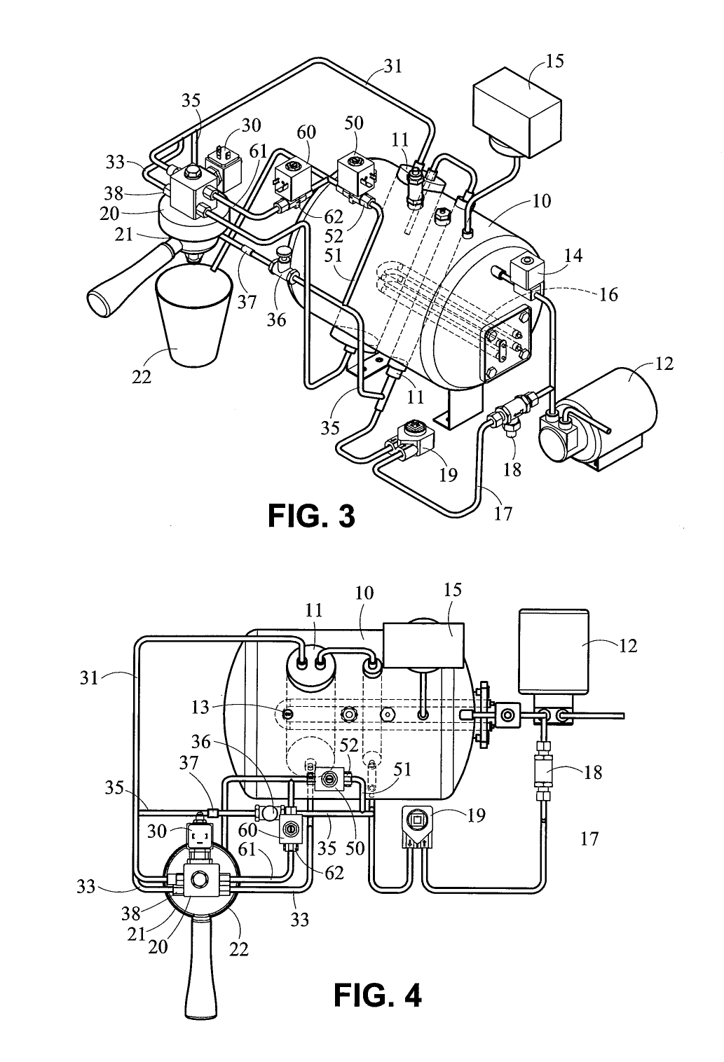

With reference to FIGS. 3 and 4 for a beverage preparing apparatus in accordance with a second preferred embodiment of the present invention, these figures are substantially the same as FIGS. 1 and 2 except that the beverage preparing apparatus of the second preferred embodiment further comprises a cold water inlet pipe 51 connected to an external water source and a cold water inlet solenoid valve 50 installed on the cold water inlet pipe 51 for controlling the cold water inlet pipe 51 to be opened or shut, such that when the cold water inlet solenoid valve 50 is opened, water from the external cold water is added into the beverage cup 22 directly to change the temperature and concentration of the beverage in the cup.

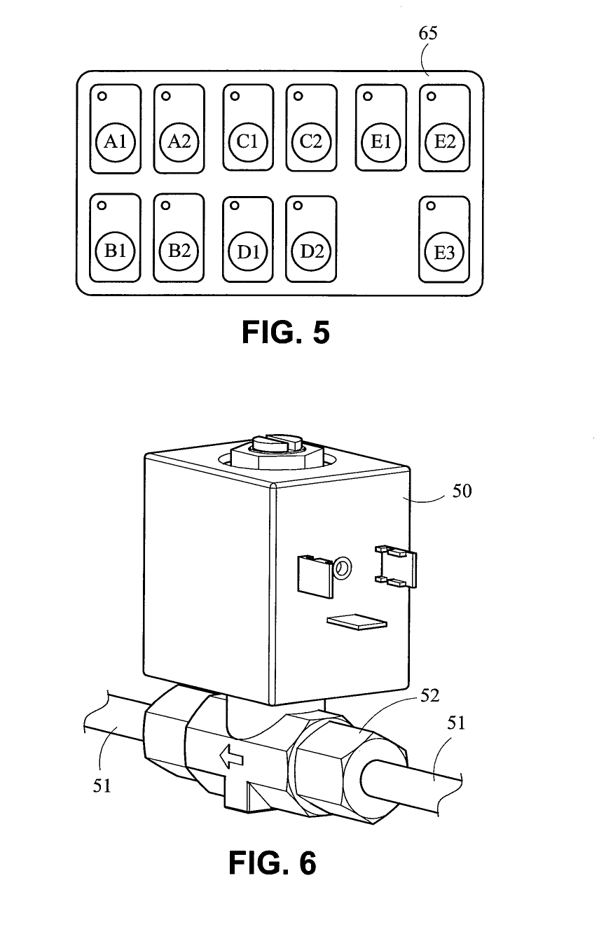

With reference to FIG. 5 for a beverage preparing apparatus of the present invention, the beverage preparing apparatus further comprises a control panel 65 installed on a casing of the beverage preparing apparatus, at least three manual control keys E1, E2, E3 and at least four automatic control keys A1, A2, B1, B2, C1, C2, D1, D2 installed on the controlled panel 65. Each manual control key E1, E2, E3 is provided for users to manually control one of the brewing solenoid valve 30, cold water inlet solenoid valve 50, and hot water inlet solenoid valve 60 to be opened or shut. Each automatic control key A1, A2, B1, B2, C1, C2, D1, D2 is preset for automatically controlling the brewing solenoid valve 30, the cold water inlet solenoid valve 50, the hot water inlet solenoid valve 60 and any combination of them to be opened or shut, and each automatic control key A1, A2, B1, B2, C1, C2, D1, D2 are factory default settings preset by manufacturers, or set or changed by user after the finished good of the beverage brewing apparatus exits factory, wherein the way of setting the factory default settings is a prior art of circuit designs, and thus will not be described here.

The flow chart is used for illustrating the operation of each of the manual control keys E1, E2, E3 and automatic control keys A1, A2, B1, B2, C1, C2, D1, D2 as follows:

Key E1: Users manually control the brewing solenoid valve 30 to adjust the quantity of outputted hot water for brewing a beverage.

Key E2: Users manually control the cold water inlet solenoid valve 50 to adjust the quantity of outputted cold water.

Key E3: Users manually control the hot water inlet solenoid valve 60 to adjust the quantity of outputted hot water.

Key A1: This key automatically controls the brewing solenoid valve 30 to be opened to a predetermined flow according to a preset value such as 50 cc for brewing a cup of concentrated beverage.

Key A2: This key automatically controls the brewing solenoid valve 30 to be opened to another predetermined flow according to a preset value such as 100 cc for brewing two cups of concentrated beverage, such as two cups of 100 cc.

Key B1: This key automatically controls the brewing solenoid valve 30 to be opened to a predetermined flow according to a preset value and the hot water inlet solenoid valve 60 to be opened to a predetermined flow to make a hot light beverage of 360 cc (including 80 cc of beverage and 280 cc of hot water at the same temperature).

Key B2: This key automatically controls the brewing solenoid valve 30 to be opened to a predetermined flow according to a preset value and the hot water inlet solenoid valve 60 to be opened to a predetermined flow to make an iced light beverage of 360 cc (including 220 cc of ice contained in a beverage cup 22, 80 cc of beverage and 60 cc of hot water at the same temperature for melting some of the ice).

Key C1: This key automatically controls the brewing solenoid valve 30 to be opened to a predetermined flow according to a preset value and the cold water inlet solenoid valve 50 to be opened to a predetermined flow to make a low-temperature light beverage of 360 cc (including 80 cc of beverage and 280 cc of cold water).

Key C2: This key automatically controls the brewing solenoid valve 30 to be opened to a predetermined flow according to a preset value and the cold water inlet solenoid valve 50 to be opened to a predetermined flow to make a low-temperature light beverage of 500 cc (including 120 cc of beverage and 380 cc of cold water).

Key D1: This key automatically controls the brewing solenoid valve 30 to be opened to a predetermined flow according to a preset value, the hot water inlet solenoid valve 60 to be opened to a predetermined flow, and the cold water inlet solenoid valve 50 to be opened for a certain period of time to make a warm light beverage of 360 cc (including 80 cc of beverage, 200 cc of hot water at the same temperature, and 80 cc of cold water).

Key D2: This key automatically controls the brewing solenoid valve 30 to be opened to a predetermined flow according to a preset value, the hot water inlet solenoid valve 60 to be opened to a predetermined flow, and the cold water inlet solenoid valve 50 to be opened for a certain period of time to make a warm light beverage of 500 cc (including 120 cc of beverage, 260 cc of hot water at the same temperature, and 120 cc of cold water).

In FIG. 6, the cold water inlet pipe 51 further includes a cold water inlet throttle connector 52 with an appropriate diameter for adjusting and setting the flow of adding water into the cold water inlet pipe 51. The cold water inlet throttle connector 52 as shown in FIG. 6 is integrally formed with the cold water inlet solenoid valve 50. Similarly, the hot water inlet pipe 61 also includes a hot water inlet throttle connector 62 (as shown in FIGS. 1 and 2. The two throttle connectors 52, 62 also can be replaced by throttle valves.

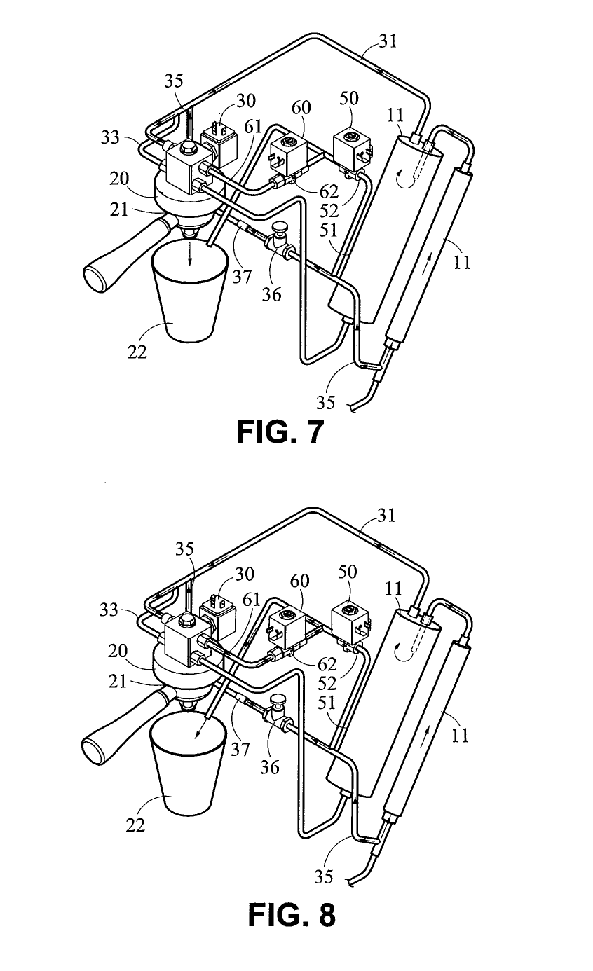

With reference to FIGS. 7 to 10 for a process of brewing a beverage in accordance with the present invention, the process includes adding hot water, adding cold water, adding warm water, and pre-heating circulation, etc.

(1) Brewing beverage: In FIG. 7, the manual control key E1 or automatic control key A1, A2 (as shown in FIG. 5) is used for turning on the water pump 12 and the brewing solenoid valve 30, and the cold water inlet solenoid valve 50 and the hot water inlet solenoid valve 60 remain shut. Now, water from an external water source is pumped by the water pump 12 in an arrowed direction as shown in FIG. 7 through the water inlet pipe 17 into the hot water pipe 31 and the cold water pipe 35. The water flowing into the hot water pipe 31 is heated to overheated hot water by the heat exchanger 11, and the quantity of water flowing into cold water pipe 35 is adjusted by the cold water throttle valve 36 and flowed into the hot water pipe 31, and mixed with the overheated hot water in the hot water pipe 31 to produce a mixed water flow with the most appropriate temperature for brewing the beverage. The mixed water flow entering into the liquid dispenser 20 and passing through the opened brewing solenoid valve 30 is delivered to a preparing container 21 that contains a beverage composition for brewing a beverage, and the prepared beverage finally flows into the beverage cup 22.

(2) Adding hot water: In FIG. 8, after the beverage brewing process is completed, if a user selects to add hot water directly into the beverage, then the user presses the manual control key E3 or the automatic control key B1, B2 (as shown in FIG. 5) during the brewing process to turn on the water pump 12 and the hot water inlet solenoid valve 60, and shut the brewing solenoid valve 30 and the cold water inlet solenoid valve 50. Now, water from an external water source is pumped by the water pump 12 to pass in an arrowed direction as shown in FIG. 8 through the water inlet pipe 17 into the hot water pipe 31 and the cold water pipe 35. The water flowing into the hot water pipe 31 is heated to an overheated hot water by the heat exchanger 11 and the quantity of water flowing into the cold water pipe 35 is adjusted by the cold water throttle valve 36, entered into the hot water pipe 31, and mixed with the overheated hot water in the hot water pipe 31 to produce a mixed water flow at a temperature most suitable for brewing the beverage. When the water flow with the appropriate temperature enters into the liquid dispenser 20, the brewing solenoid valve 30 is shut, so that the water flow is guided into the hot water inlet pipe 61, passed through the opened hot water inlet solenoid valve 60, and filled into the beverage cup 22 directly to reduce the concentration of the beverage without changing the temperature of the beverage.

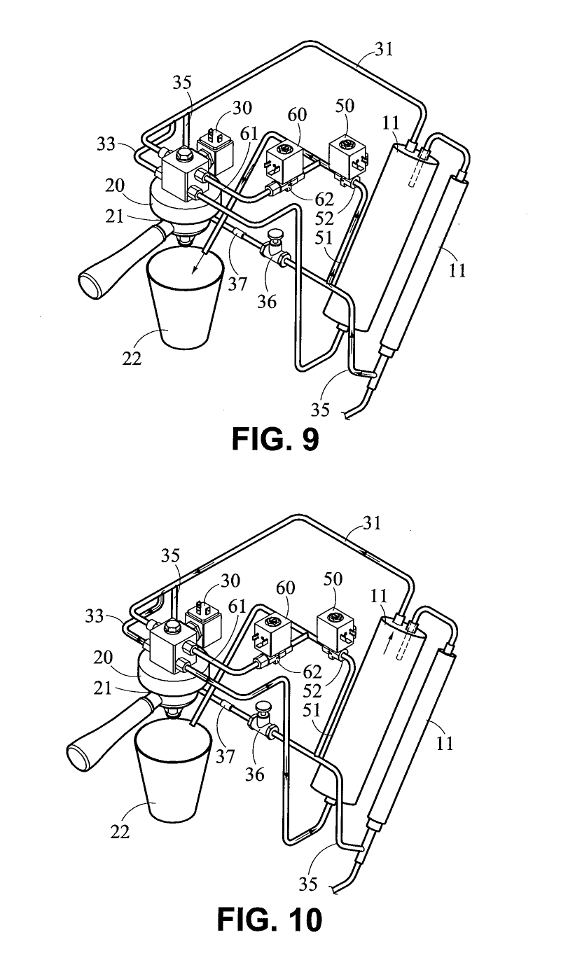

(3) Adding cold water: In FIG. 9, after the beverage brewing process is completed, if the user selects to add cold water into the beverage directly, then the user uses the manual control key E2 or selects the automatic control key C1, C2 (as shown in FIG. 5) to turn on the water pump 12 and cold water inlet solenoid valve 50 and shut the brewing solenoid valve 30 and hot water inlet solenoid valve 60 during the brewing process. Now the water from the external water source is pumped by the water pump 12 in a direction as shown in FIG. 9 through the water inlet pipe 17 into the cold water inlet pipe 51, passed through the opened cold water inlet solenoid valve 50, and filled into the beverage cup 22 directly, so as to reduce both concentration and temperature of the beverage at the same time. It is noteworthy to point out that both brewing solenoid valve 30 and hot water inlet solenoid valve 60 are shut during the process of adding cold water, and thus no water substantially flows into the hot water pipe 31 and the cold water pipe 35.

(4) Adding warm water: Hot water and cold water are added into the beverage cup 22 directly by the aforementioned processes of adding hot water and cold water respectively to reduce both concentration and temperature of the beverage at the same time.

(5) Pre-heating circulation: In FIG. 10, when the beverage preparing apparatus is idled, the water pump 12, the brewing solenoid valve 30, the cold water inlet solenoid valve 50 and the hot water inlet solenoid valve 60 are shut, and the hot water in the heat exchanger 11 vaporizes to steam by the heat of vaporization, and the steam flows in an arrowed direction as shown in FIG. 10 through the hot water pipe 31 into the pre-heating circulation pipeline 33, and passes through the liquid dispenser 20 for performing the heat exchange with the liquid dispenser 20, such that the flow of preheating steam set by the throttle connector 38 pre-heats the liquid dispenser 20 to an appropriate operating temperature, and the condensed water is returned to the heat exchanger 11 through the pre-heating circulation pipeline 33 after the heat exchange takes place to constitute a pre-heating circulation.

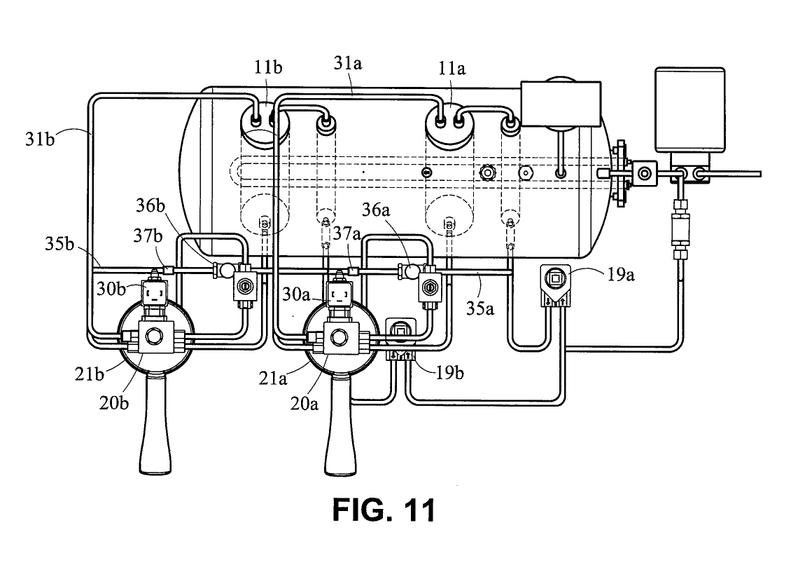

The beverage preparing apparatus of the present invention mixes overheated hot water with a quantity of cold water adjusted by the cold water throttle valve 36 to produce a mixed water flow at a temperature most suitable for brewing a beverage, and the mixed water is supplied to the liquid dispenser 20, and delivered and entered into the preparing container 21 for brewing a beverage. This method of mixing the overheated hot water with the cold water to produce the mixed water flow for brewing the beverage not only improves the operating efficiency of the boiler, but also provides a way of changing the temperature of the mixed water flow to the appropriate temperature by changing the preset quantity of cold water. In With reference to FIG. 11, two sets of brewing units are installed in the beverage preparing apparatus, the apparatus comprises two sets of flow meters 19a, 19b, heat exchangers 11a, 11b; hot water pipes 31a, 31b; cold water pipes 35a, 35b; cold water throttle valves 36a, 36b; check valves 37a, 37b; liquid dispensers 20a, 20b; brewing solenoid valves 30a, 30b and preparing containers 21a, 21b, wherein each set is operated independently, and the two cold water throttle valves 36a, 36b are preset to different flows of cold water to provide different brewing temperatures suitable for brewing different beverages by adding warm water from two liquid dispensers 20a, 20b, so as to achieve the effect of brewing various different beverages by the same beverage preparing apparatus.

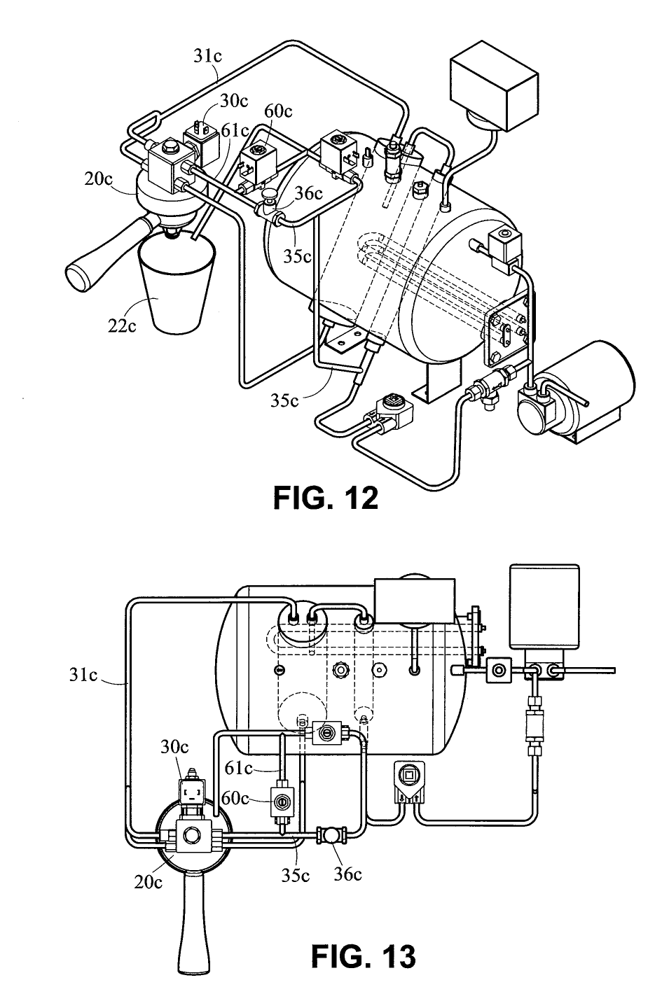

With reference to FIGS. 12 and 13 for a beverage preparing apparatus in accordance with a fourth preferred embodiment of the present invention, this preferred embodiment is substantially the same as the second preferred embodiment shown in FIGS. 3 and 4, except that the beverage preparing apparatus of the fourth preferred embodiment connects the cold water pipe 35c with the hot water pipe 31c through the liquid dispenser 20c, such that the overheated hot water from the hot water pipe 31c is mixed with a specific quantity of cold water from the cold water pipe 35c to produce a mixed water flow at a temperature most suitable for brewing the beverage in the liquid dispenser 20c. The hot water inlet pipe 61c can be connected to the cold water pipe 35c between the liquid dispenser 20c and the cold water throttle valve 36c, such that when the brewing solenoid valve 30c is shut and the hot water inlet solenoid valve 60c is opened, the mixed water at an appropriate temperature is added into the beverage cup 22 directly to reduce the concentration of the beverage without changing the temperature of the beverage.

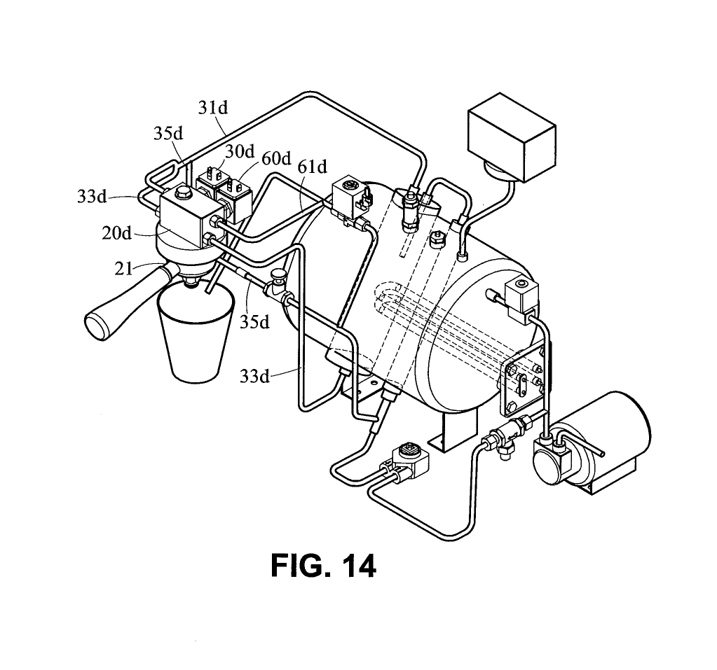

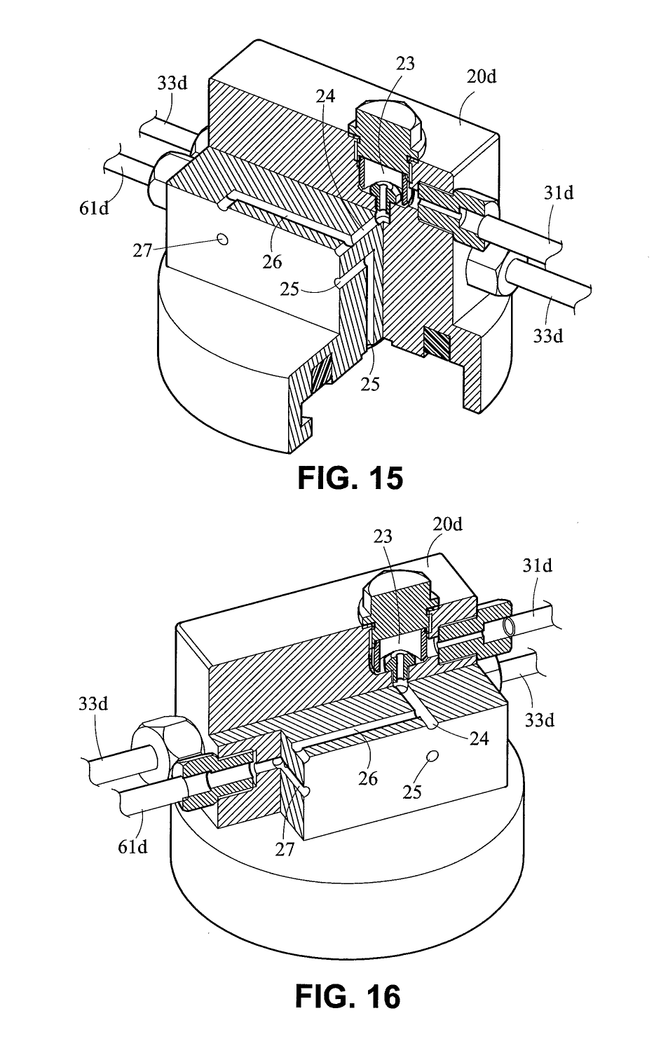

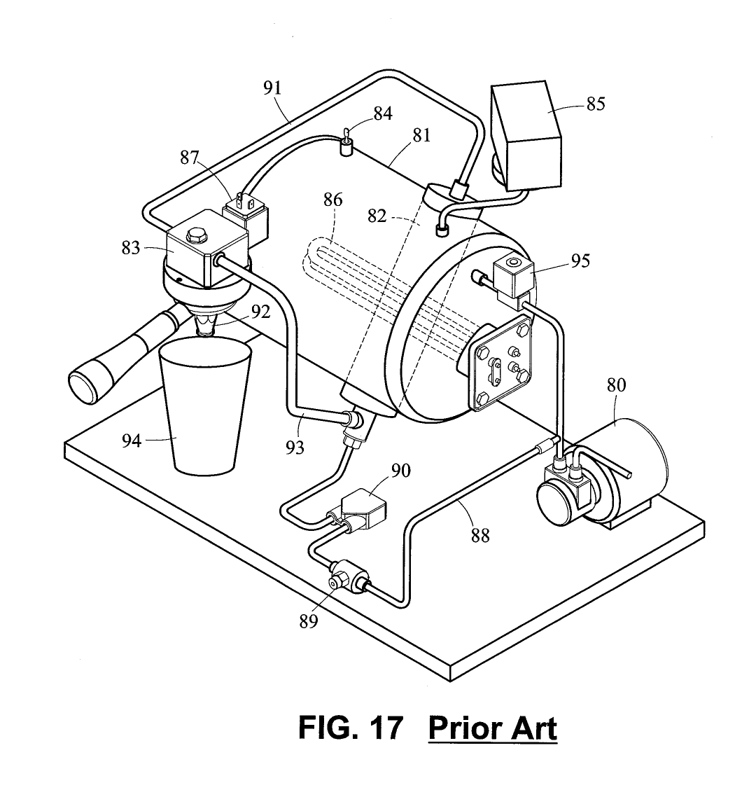

With reference to FIGS. 14 to 16 for a beverage preparing apparatus in accordance with a fifth preferred embodiment of the present invention, this preferred embodiment is substantially the same as the second preferred embodiment shown in FIGS. 3 and 4, except that the beverage preparing apparatus of the fifth preferred embodiment changes the position of the hot water inlet solenoid valve 60d originally installed on the hot water inlet pipe 61d to a position on the liquid dispenser 20d. Now, some portions of structure of the liquid dispenser 20d are changed accordingly as shown in FIGS. 15 and 16. The liquid dispenser 20d includes a baffle base 23 for receiving a mixed water flow at an appropriate temperature produced by mixing the overheated hot water from the hot water pipe 31d with the specific quantity of cold water from the cold water pipe 35d. When the brewing solenoid valve 30d is opened, and the hot water inlet solenoid valve 60d is shut, the mixed water flow at an appropriate water in the baffle base 23 enters into a water supply passage 24, passes through the opened brewing solenoid valve 30d to enter into a water exit passage 25, and flows into the preparing container 21 for performing the beverage brewing process. When the brewing solenoid valve 30d is shut and the hot water inlet solenoid valve 60d is opened, the mixed water flow at an appropriate temperature in the baffle base 23 enters into the water supply passage 24 and a water supply branch passage 26, passes through the opened hot water inlet solenoid valve 60d to enter into a water supply passage 27, and flows into the hot water inlet pipe 61d for performing the aforementioned process of adding hot water. When both brewing solenoid valve 30d and hot water inlet solenoid valve 60d are shut, no substantial water flow is in the baffle base 23. When the beverage preparing apparatus is idled, the hot water vaporizes to steam for performing the aforementioned pre-heating circulation through the pre-heating circulation pipeline 33d and the liquid dispenser 20d.

The beverage preparing apparatus of the present invention can adjust the temperature and concentration of the brewed beverage automatically according to the foregoing predetermined settings in order to make beverages at different temperatures and concentrations, such as concentrated coffee (tea), light coffee (tea), hot coffee (tea), warm coffee (tea), and iced coffee (tea) to meet the actual requirement of a diversified beverage market. In the meantime, the invention can achieve the objective of brewing various different beverages by using the same beverage preparing apparatus, so that beverage makers can reduce equipment cost, and achieve a convenient operation and a high equipment utilization rate.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A beverage preparing apparatus, comprising:
a boiler, for heating water stored therein to a predetermined temperature range;
a hot water pipe, connected to an external water source, and passed through a heat exchanger installed in the boiler, for heating a water flow passing through the hot water pipe to an overheated temperature value;
a cold water pipe, connected to the external water source, passed through a cold water throttle valve for adjusting a flow, and then connected to the hot water pipe, such that the cold water and the hot water are mixed into a water flow with an appropriate temperature;
a check valve, installed on the cold water pipe, for preventing the water flow in the hot water pipe from flowing in a reverse direction back into the cold water pipe;
a liquid dispenser, connected to the hot water pipe, for receiving the water flow from the hot water pipe;
a preparing container, assembled with the liquid dispenser, and having a beverage composition contained in the preparing container;
a hot water inlet pipe, connected to the hot water pipe through the liquid dispenser;
a hot water inlet solenoid valve, for controlling the hot water inlet pipe to be opened or shut; and
a brewing solenoid valve, installed onto the liquid dispenser, such that when the brewing solenoid valve is opened, the liquid dispenser delivers a mixed water flow at an appropriate temperature into the preparing container to produce a beverage by the beverage composition, and when the brewing solenoid valve and the hot water inlet solenoid valve are opened, the liquid dispenser delivers a mixed water flow at an appropriate temperature into the hot water inlet pipe and adds the mixed water in the beverage.

2. The beverage preparing apparatus of claim 1, further comprising a pre-heating circulation pipeline, with an end connected to the hot water pipe, and another end passed through the liquid dispenser directly, and then connected to the heat exchanger, such that when the brewing solenoid valve and the hot water inlet solenoid valve are shut, the hot water in the heat exchanger is vaporized and passed through the pre-heating circulation pipeline to pre-heat the liquid dispenser, and then returned to the heat exchanger.

3. The beverage preparing apparatus of claim 1, further comprising a cold water inlet pipe connected to an external water source and a cold water inlet solenoid valve provided for controlling the cold water inlet pipe to be opened or shut, such that when the cold water inlet solenoid valve is opened, the external cold water is passed through the cold water inlet pipe to add the cold water in the beverage.

4. The beverage preparing apparatus of claim 1, wherein the cold water pipe is connected to the hot water pipe before the hot water pipe enters into the liquid dispenser.

5. The beverage preparing apparatus of claim 1, wherein the cold water pipe is connected to the hot water pipe through the liquid dispenser.

6. The beverage preparing apparatus of claim 3, further comprising a control panel, having at least three manual control keys and at least four automatic control keys, and the manual control keys being provided for manually and respectively controlling the brewing solenoid valve, the cold water inlet solenoid valve and the hot water inlet solenoid valve, and the automatic control keys being preset and provided for automatically and respectively controlling the brewing solenoid valve, the cold water inlet solenoid valve, the hot water inlet solenoid valve and their combinations.

7. The beverage preparing apparatus of claim 1, further comprising at least two sets of cold water pipes, cold water throttle valves, hot water pipes and liquid dispensers, and the cold water throttle valves providing different flows of cold water to the cold water pipes, and the hot water in the sets of hot water pipe being mixed to form a mixed water flow of an appropriate temperature and delivered to the liquid dispensers.

8. The beverage preparing apparatus of claim 1, wherein the hot water inlet solenoid valve is installed on the hot water inlet pipe.

9. The beverage preparing apparatus of claim 1, wherein the hot water inlet solenoid valve is installed on the liquid dispenser, such that when the brewing solenoid valve is opened and the hot water inlet solenoid valve is shut, the mixed water flow at an appropriate temperature flows into a water supply passage of the liquid dispenser, passes through the opened brewing solenoid valve into a water exit passage, and flows into the preparing container for performing a beverage brewing process, and when the brewing solenoid valve is shut and the hot water inlet solenoid valve is opened, the mixed water flow at the appropriate temperature passes through the water supply passage, and then the opened hot water inlet solenoid valve into a water supply branch passage, and flows into the hot water inlet pipe.
